(19) United States
(12) Patent Application Publication
(10) Pub. No.: US 2026/0207411 A1
(43) Pub. Date: Jul. 23, 2026

(54) FUNERARY URN

(71) Applicant: TITAN CASKET CORP., Methuen, MA (US)

(72) Inventor: Scott Ginsberg, Methuen, MA (US)

(21) Appl. No.: 19/035,747

(22) Filed: Jan. 23, 2025

(51) Int. Cl. A61G 17/08

(52) U.S. Cl. CPC A61G 17/08

(57) ABSTRACT

The invention involves a system and method for constructing a funeral urn to accept ashes of an animal within a flexible container. The system includes a lower urn portion and an upper urn portion, each having a helical thread, bayonet mount or other fastener combination arranged around the bulbous portion of the urn which allows the urn to be separated and reassembled. In this manner, the user can open the urn and place a bag containing the ashes into the funeral urn and reassemble the funeral urn including the ashes and the bag without pouring the ashes into the urn.

### FIELD OF INVENTION

The present invention generally relates to funerary urns and, more particularly, to a funerary urn that is constructed and arranged to open at the widest portion of the urn container to allow ashes to be more easily placed within the urn.

### BACKGROUND INFORMATION

Funerary urns (also called cinerary urns and burial urns) have been used by many civilizations over centuries of time. After death, corpses are often cremated, and the ashes are collected for burial, broadcasting, display or the like. Pottery urns, dating from about 7000 BC, have been found in an early Jiahu site in China, and other early finds are in Laoguantai, Shaanxi. In addition, several burial urns have been unearthed in the Yangshao areas that date to 5000-3000 BC. These historic burial urns were used mainly for children, but also sporadically for adults.

The Urnfield culture (c. 1300 BC-750 BC), was a late Bronze Age culture from central Europe. The Urnfield culture takes its name from its large cemeteries of urn burials. The discovery of a Bronze Age urn burial in Norfolk, England, prompted Sir Thomas Browne to describe the antiquities found. He expanded his study to survey burial and funerary customs, ancient and current, and published it as Hydriotaphia, Urn Burial (1658).

In ancient Greece, cremation was usual, and the ashes were typically placed in a painted Greek vase. In particular, the lekythos, a vase, was used for holding oil in funerary rituals. Romans placed the urns in a niche in a collective tomb called a columbarium (dovecote). The interior of a dovecote usually has niches to house doves. Cremation urns were also commonly used in early Anglo Saxon England, and in many Pre-Columbian cultures.

In some later European traditions, a king's heart, and sometimes other organs, would be placed in one or more urns upon his death, as happened with King Otto of Bavaria in 1916, and buried in a different place from the body to symbolize a particular affection for the place by the departed.

In the modern funeral industry, cremation urns of varying quality, elaborateness, and cost are offered. Biodegradable urns are sometimes used for both human and animal burial. They are made from eco-friendly materials, such as recycled or handmade paper, salt, cellulose or other natural products, that are capable of decomposing back into natural elements, and sometimes include a seed intended to grow into a tree at the site of the burial. Cremation or funeral urns are made from a variety of materials, such as wood, natural stone, ceramic, glass, or steel. In modern times, much the same as previous times, the urn often includes a narrow base that expands to a larger diameter and then narrows again to the opening. Once the body is cremated, it is most often placed into a plastic bag and thereafter into a carboard box for transport to the funeral home. At the funeral home, the ashes are removed from the box and poured from the bag into the narrow neck of the urn. When this occurs, a portion of the ashes become airborne, subjecting those pouring the ashes to breathing in a portion of the human remain ashes. In addition, a small amount of the ashes settle around the room and onto the skin of anyone in the room as dust. Thus, what is needed in the art is a redesigned urn that allows for the ashes to remain in the plastic bag, or another suitable container, wherein the entire bag or container with the ashes can be placed within the urn and the urn then closed. This construction provides the added benefit of allowing the custodian of the ashes to change the urn periodically or distribute portions of the ashes to other family members without having to manually handle the ashes.

There are ergonomic needs that a funeral urn must satisfy in order to achieve acceptance by the end user. The urn itself must be easily and quickly disassembled and assembled using minimal hardware and requiring a minimal number of tools. Further, the system should not require excessive strength to assemble or include heavy component parts. Moreover, the system must assemble together in such a way so as not to detract from the aesthetic appearance of the assembled funeral urn.

Thus, the present invention provides a funeral urn that breaks apart at a suitably large area of the urn to place a bag or other flexible container containing ashes within the urn. This construction overcomes the disadvantages of prior art by allowing the plastic bag or container including the ash contents to be placed into the urn as a single unit in place of pouring the ashes. The funerary urn then assembles back into a single piece without the need for tools, and provides an aesthetically pleasing urn which may include a traditional appearance.

### SUMMARY OF THE INVENTION

Briefly, the invention involves a system and method for constructing a funeral urn to accept ashes of an animal packaged within a bag or container. The system includes a lower urn portion and an upper urn portion, each having a helical thread, bayonet mount or other fastener combination arranged around the bulbous portion or larger diameter of the urn, which allows the urn to be separated and reassembled. In this manner, the user can open the urn and place a container containing ashes into the funeral urn and then reassemble the funeral urn including the ashes and the container without pouring the ashes into the urn.

Accordingly, it is an objective of the present invention to provide a funeral urn that separates in the sufficiently large area to place a bag, flexible container or the like, including the ash remains of a human within the urn.

It is a further objective of the present invention to provide a funeral urn that includes portions of a fastener on each half of the urn for separation and reassembly.

It is yet a further objective of the present invention to provide a funeral urn having a rounded body constructed to separate at the rounded portion.

It is another objective of the present invention to provide a vase type urn constructed to separate in a middle portion of the vase type urn.

It is still yet another objective of the present invention to provide a funerary urn that facilitates placing ashes within the urn while in a bag or container to eliminate pouring the ashes.

Other objectives and advantages of this invention will become apparent from the following description taken in conjunction with the accompanying drawings wherein are set forth, by way of illustration and example, certain embodiments of this invention. The drawings constitute a part of this specification and include exemplary embodiments of the present invention and illustrate various objects and features thereof.

### BRIEF DESCRIPTION OF THE FIGURES

FIG. 1 is a top front perspective view of one embodiment of a funeral urn constructed to separate at the large diameter portion of the urn;

FIG. 2 is a top front perspective view of the funeral urn embodiment illustrated in FIG. 1;

FIG. 3 is a top view of the embodiment shown in FIG. 1;

FIG. 4 is a bottom view of the embodiment shown in FIG. 1;

FIG. 5 is a top front perspective view of another embodiment of the funeral urn illustrating placement of the ashes within the bag into the urn; and

FIG. 6 is a top front perspective view of an embodiment having a polygonal outer shape.

### DETAILED DESCRIPTION OF THE PREFERRED EMBODIMENTS

While the present invention is susceptible of embodiment in various forms, there is shown in the drawings and will hereinafter be described a presently preferred embodiment with the understanding that the present disclosure is to be considered an exemplification of the invention and is not intended to limit the invention to the specific embodiments illustrated.

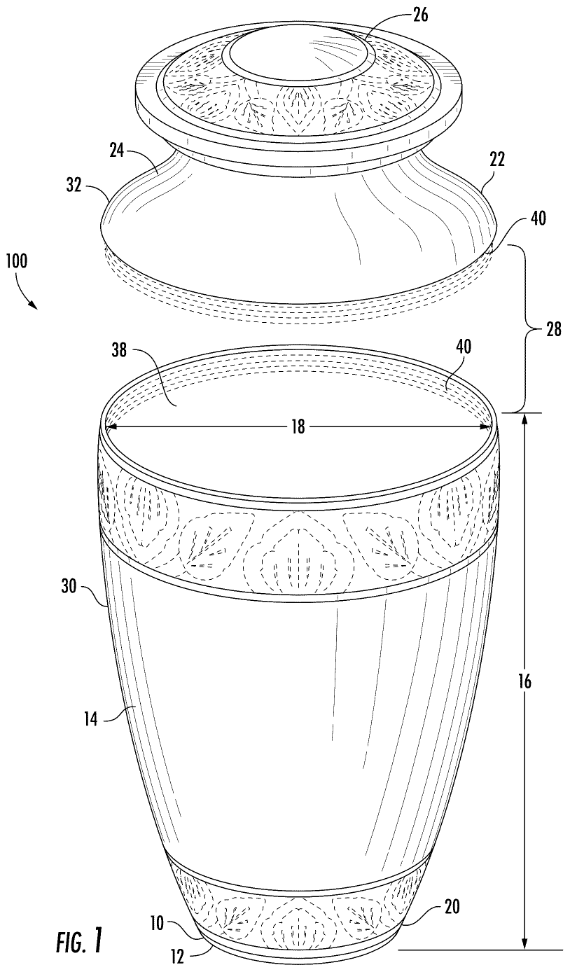

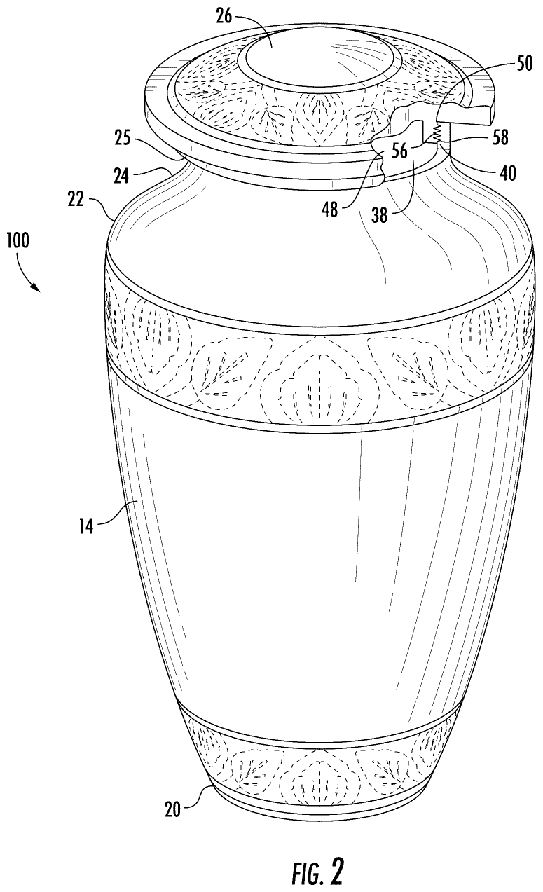

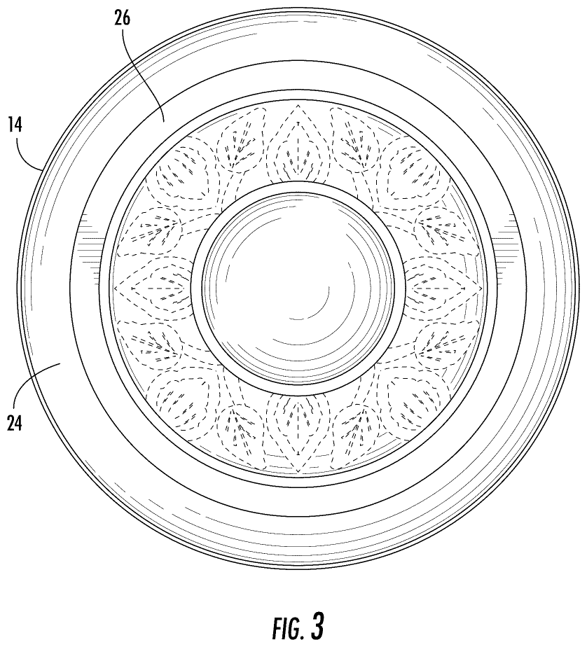

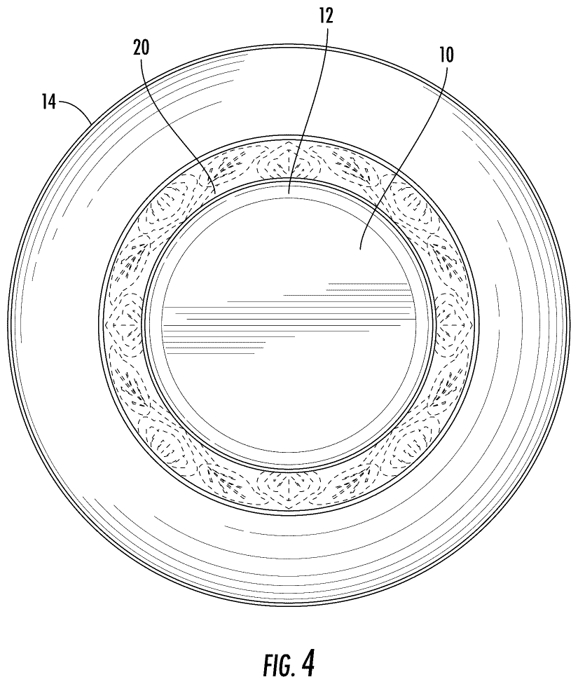

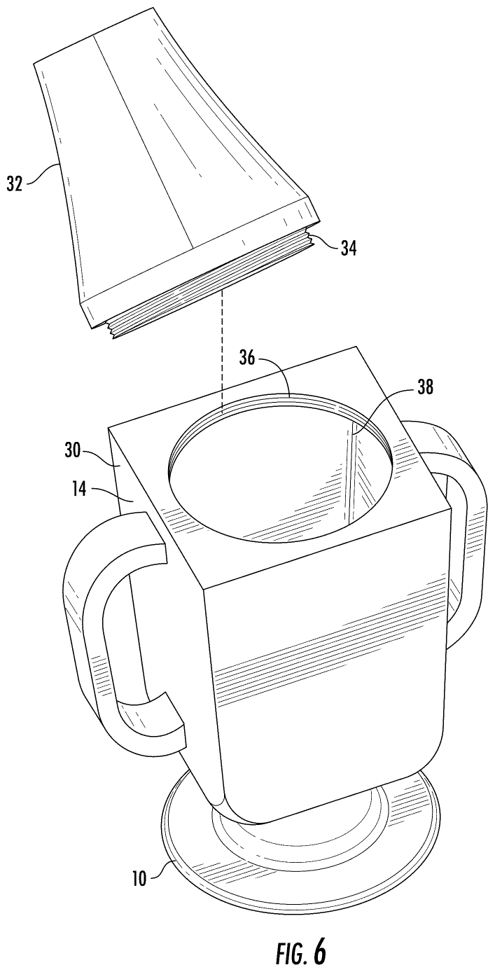

Referring generally to FIGS. 1-6, a funerary urn 100 for containing the ashes of a cremated animal, preferably human, is illustrated. The funerary urn 100 has a base 10 including a flat bottom surface 12 for supporting the funerary urn on a surface in an upright position. A body portion 14 is secured, or integrally formed, to the base 10. In a preferred embodiment, the body portion 14 includes a height 16 that is greater than the diameter 18; the body 14 including a bulbous shape, when viewed from the side, having an outwardly curving foot portion 20 connected to the base 10 and a shoulder portion 22 that curves inwardly for connection to a neck portion 24. The neck portion may or may not include a neck opening 48. The neck opening 48 may include a cover portion 26 or lid to selectively cover the neck opening when included.

Still referring generally to FIGS. 1-6, the body 14 preferably includes a separable fastener assembly 28 which allows the body portion 14 to be separated for insertion of the ashes of an animal, most preferably contained within a flexible container such as, but not limited to, a plastic bag, vacuum bag, container or the like, before reclosing the body portion. In some embodiments, the plastic bag may be sealed and/or vacuumed with respect to air contained within the bag. It should be noted that other containers, some of which may include a shape specific to the cavity within the urn may be utilized without departing from the scope of the invention. Separation of the separable fastener assembly 28 thus separates the body 14 of the funerary urn 100 into a first part 30 and a second part 32. In the preferred embodiment, the first part 30 of the separable fastener 28 includes a first portion 36 of the separable fastener 28, while the second part 32 includes a second portion 34 of the separable fastener 28. In general, the first and second portions of the separable fastener 28 are constructed and arranged to secure the funerary urn 100 together as a single piece. In some embodiments, an o-ring or seal or the like (not shown) may be utilized to seal the internal cavity 38. In a most preferred embodiment, the separable fastener assembly 28 includes mating helical threads 40 constructed and arranged to releasably intermesh with each other. The threads 40 may take several forms including, but not limited to, single lead V-threads, double lead V-threads, acme threads, buttress threads, Whitworth threads or the like without departing from the scope of the invention. Alternatively, other fasteners may be utilized without departing from the scope of the invention; such fasteners may include, but should not be limited to, bayonet mounts 42, magnets, friction fits, locking tapers, hinges, latches, pinch bolts and the like.

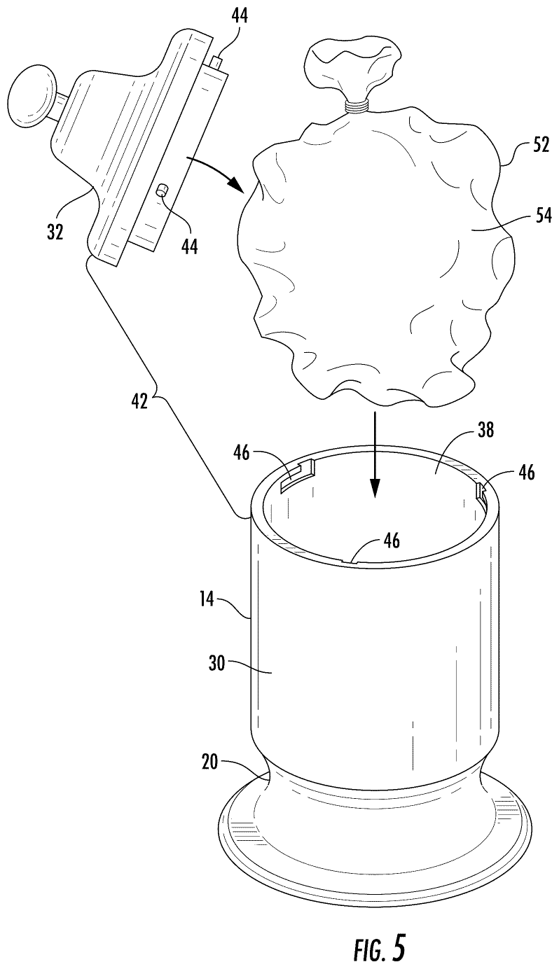

As exemplary example, the bayonet arrangement includes a bayonet portion 44 forming one of the first portion 36 or the second portion 34 of the separable fastener and a bayonet receiver 46 (FIG. 5) forming the other of the respective first portion or second portion of the separable fastener; the bayonet 44 and bayonet receiver 46 being constructed and arranged to intermesh with each other, requiring less than one complete turn of the respective first portion or second portion with respect to the opposite first or second portion in a first direction to complete the intermeshing and less than one complete turn in a second direction to complete a disengagement of the first portion and the second portion of the separable fastener. It should be noted that in the embodiments including the cover 26, the neck opening 48 may include a second separable fastener 50 having a first portion 56, the cover portion including a second portion 58 of the second separable fastener. Like the first fastener assembly 28, threads, bayonets, magnets, friction fits, locking tapers, hinges, latches, pinch bolts and the like may be utilized to secure the cover to the neck portion 24. In some embodiments, the neck portion 24 may include an outwardly flaring lip 25 that may extend completely or just partially around the neck portion. It should also be noted that while the funerary urn 100 is illustrated as round in shape when viewed from the top, other shapes including polygons, ovals, novelty shapes such as footballs, soccer balls, hearts, birds, etc. and the like may be utilized without departing from the scope of the invention.

It is to be understood that while a certain form of the invention is illustrated, it is not to be limited to the specific form or arrangement herein described and shown. It will be apparent to those skilled in the art that various changes may be made without departing from the scope of the invention, and the invention is not to be considered limited to what is shown and described in the specification and any drawings/figures included herein.

One skilled in the art will readily appreciate that the present invention is well adapted to carry out the objectives and obtain the ends and advantages mentioned, as well as those inherent therein. The embodiments, methods, procedures and techniques described herein are presently representative of the preferred embodiments, are intended to be exemplary, and are not intended as limitations on the scope. Changes therein and other uses will occur to those skilled in the art which are encompassed within the spirit of the invention and are defined by the scope of the appended claims. Although the invention has been described in connection with specific preferred embodiments, it should be understood that the invention as claimed should not be unduly limited to such specific embodiments. Indeed, various modifications of the described modes for carrying out the invention, which are obvious to those skilled in the art, are intended to be within the scope of the following claims.

1. A funerary urn for containing the ashes of a cremated animal comprising:
a funerary urn having a base including a flat bottom surface for supporting the funerary urn on a surface in an upright position, a body portion secured to the base, the body having a height that is greater than a diameter, the body including a bulbous shape having an outwardly curving foot portion connected to the base and a shoulder portion that curves inwardly for connection to a neck portion, the neck portion terminating in a cover portion, the bulbous portion including a separable fastener assembly which allows the bulbous portion to be separated, thereby separating the funerary urn into a first part and a second part, the first part including a first portion of the separable fastener, while the second part includes a second portion of the separable fastener, the first and second portions of the separable fastener being constructed and arranged to secure the funerary urn together as a single piece; an internal cavity being located within the bulbous shape of the body portion, the internal cavity sized to accept the ashes of a cremated animal.

2. The funerary urn of claim 1 wherein the separable fastener assembly includes helical threads constructed and arranged to releasably intermesh with each other.

3. The funerary urn of claim 1 wherein the separable fastener assembly is a bayonet mount, the bayonet mount including a bayonet portion forming one of the first portion or the second portion of the separable fastener and a receiver forming the other of the first portion or second portion of the separable fastener, the bayonet and bayonet receiver constructed and arranged to intermesh with each other, requiring less than one complete turn of the respective first portion or second portion with respect to the opposite first or second portion in a first direction to complete the intermeshing and less than one complete turn in a second direction to complete a disengagement of the first portion and the second portion of the separable fastener.

4. The funerary urn of claim 1 wherein the neck portion includes a neck opening.

5. The funerary urn of claim 4 wherein the cover portion is constructed and arranged to cover the neck opening.

6. The funerary urn of claim 1 wherein the funerary urn is round when viewed from the top.

7. urn of claim 1 wherein the funerary urn is a polygon when viewed from the top.

8. The funerary urn of claim 1 wherein the neck portion includes an outwardly flaring lip.

9. The funerary urn of claim 5 wherein the inside of the neck opening includes a first portion of a second separable fastener assembly, the cover portion including a second portion of the second separable fastener.

10. The funerary urn of claim 9 wherein the first and second portion of the second separable fastener assembly includes helical threads constructed and arranged to releasably intermesh with each other.

11. The funerary urn of claim 1 wherein the ashes of the cremated animal are contained within a flexible container, the cavity sized to accept the ashes and the flexible container.

12. The funerary urn of claim 11 wherein the flexible container is a bag.

13. The funerary urn of claim 12 wherein the bag is constructed from plastic.

14. The funerary urn of claim 13 wherein the bag is sealed.

15. The funerary urn of claim 1 wherein the animal ashes are human ashes from a cremation.
